(19) United States
(12) Patent Application Publication
(10) Pub. No.: US 2006/0170800 A1
(43) Pub. Date: Aug. 3, 2006

(54) Solid state image pickup device

(75) Inventor: Tatsuya Hagiwara, Kurokawa-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO. LTD.

(21) Appl. No.: 11/320,759

(22) Filed: Dec. 30, 2005

(30) Foreign Application Priority Data
Feb. 2, 2005 (JP) 2005-026776

(51) Int. Cl. H04N 5/335

(52) U.S. Cl. 348/294

(57) ABSTRACT

A solid state image pickup device has: a semiconductor substrate having a light reception area and formed with a solid state image pickup device; a base formed on the semiconductor substrate in an area outside the light reception area; a first member bonded to a partial surface of the base; a recess formed in the base in an area between the light reception area and the first member; and a second member supported by the first member, disposed over the light reception area and hermetically sealing the light receiving area. A high quality solid state image pickup device is provided.

### CROSS REFERENCE TO RELATED APPLICATION

This application is based on and claims priority of Japanese Patent Application No. 2005-026776 filed on Feb. 2, 2005, the entire contents of which are incorporated herein by reference.

### BACKGROUND OF THE INVENTION

A) Field of the Invention

The present invention relates to a solid state image pickup device.

B) Description of the Related Art

As a portable phone having a built-in digital camera prevails, there are demands for a compact solid state image pickup device to be used in the phone.

A compact solid state image pickup device with micro lenses is disclosed, for example, in Japanese Patent Laid-open Publication No. HEI-7-202152. In this solid state image pickup device, a sealing member made of transparent material and integrally forming a frame on a lower edge area is disposed only in a light reception area of a solid state image pickup device chip having the light reception area with micro lenses.

A method of facilitating the manufacture of a compact and highly reliable solid state image pickup device is disclosed, for example, in Japanese Patent Laid-open Publication No. 2004-6834.

Various methods have been proposed by which a member such as a package is bonded directly or via an intermediate member (e.g., base) to a semiconductor substrate formed with a solid state image pickup device in order to meet requirements for compact solid state image pickup devices.

FIGS. 4A to 4D are cross sectional views briefly illustrating some processes of a manufacture method for a solid state image pickup device of a chip size level.

Reference is made to FIG. 4A. A semiconductor substrate (wafer) 81 is prepared which is formed with solid state image pickup devices 20 and pads 21 for connection to external wirings.

Spacers 23 are formed on a transparent protective glass 22, and adhesive 24b is transferred to the spacer 23. The protective glass 22 is disposed facing the semiconductor substrate 81.

The spacers 23 are formed by coating adhesive 24a on the protective glass 22, placing a silicon substrate on the adhesive layer to adhere the silicon substrate to the protective glass, polishing the silicon substrate to a desired thickness when necessary, and performing photolithography and dry etching to form predetermined spacer shapes.

Reference is made to FIG. 4B. The semiconductor substrate 81 is bonded to the protective glass 22 formed with the spacers 23. A number of solid state image pickup devices are formed at a wafer level, having the structure hermetically sealing a light reception area of each solid state image pickup device 20.

Reference is made to FIG. 4C. The protective glass is polished and cut with a grind stone to divide the protective glass 22 and expose the pads 21.

Reference is made to FIG. 4D. The semiconductor substrate 81 is polished and cut along an area between pads 21 with a grind stone to form solid state image pickup devices 25 of a chip size level.

FIG. 5A is a schematic partial plan view of the solid state image pickup device of a chip size level manufactured by the manufacture method described with reference to FIGS. 4A to 4D. FIG. 5B is a schematic cross sectional view taken along line 5B-5B shown in FIG. 5A. In FIGS. 5A and 5B, the protective glass 22, pads 21 and the like of the solid state image pickup device 25 shown in FIG. 4D are omitted.

Reference is made to FIG. 5A. The spacer 23 is formed on the principal surface of the semiconductor substrate formed with photodiodes, surrounding the outer peripheral area of a light reception area 26 as viewed in plan. A thickness (height) of the spacer is, for example, 100 μm.

The spacer 23 is adhered to a base 27 for the spacer 23 formed on the semiconductor substrate, for example, with adhesive. The base 27 for the spacer 23 is formed at the same time when micro lenses of the solid state image pickup device are formed, by using the same material as that of the micro lenses.

The base 27 is formed on the semiconductor substrate in an area broader than the bonding area of the spacer 23. In FIG. 5A, the area where the base 27 is formed is indicated by oblique lines.

Reference is made to FIG. 5B. As described with reference to FIG. 4B, the spacer 23 transferred with the adhesive 24b is bonded to the base 27 formed on the semiconductor substrate 81. In this case, the adhesive 24b may flow into the area (light reception area side) inner than the bonding area of the spacer 23. The outflow of the adhesive 24b is indicated by a dot-line arrow in FIG. 5B.

If the outflowed adhesive 24b reaches the light reception area, the optical characteristics of this area are adversely affected. The outflowed adhesive is likely to be extended broadly by a capillary phenomenon, particularly in a solid state image pickup device having micro lenses 85 disposed densely.

### SUMMARY OF THE INVENTION

An object of this invention is to provide a high quality solid state image pickup device.

According to one aspect of the present invention, there is provided a solid state image pickup device comprising: a semiconductor substrate having a light reception area and formed with a solid state image pickup device; a base formed on the semiconductor substrate in an area outside the light reception area; a first member bonded to a partial surface of the base; a recess formed through the base in an area between the light reception area and the first member; and a second member supported by the first member, disposed above the light reception area and hermetically sealing the light receiving area.

Even if adhesive outflows when the first member of the solid state image pickup device is bonded, the adhesive can be flowed into the recess so that the quality of the solid state image pickup device can be prevented from being degraded. A high quality solid state image pickup device can therefore be formed.

According to the present invention, a high quality solid state image pickup device can be provided.

### BRIEF DESCRIPTION OF THE DRAWINGS

FIG. 1A is a block diagram showing a main part of a solid state image pickup device having solid state image pickup elements, FIGS. 1B and 1C are schematic plan views showing the structure of a CCD type solid state image pickup device, FIG. 1D is a circuit diagram of a MOS type solid state image pickup element, and FIG. 1E is a schematic cross sectional view showing a portion of a light reception unit of a CCD type solid state image pickup element.

FIG. 2A is a schematic partial plan view of a solid state image pickup device according to an embodiment, and FIG. 2B is a schematic cross sectional view taken along line 2B-2B shown in FIG. 2A.

FIGS. 3A and 3B are schematic cross sectional views of solid state image pickup devices having pads formed on one side and both sides of semiconductor substrates.

FIGS. 4A to 4D are cross sectional views briefly illustrating some processes of a manufacture method for a solid state image pickup device of a chip size level.

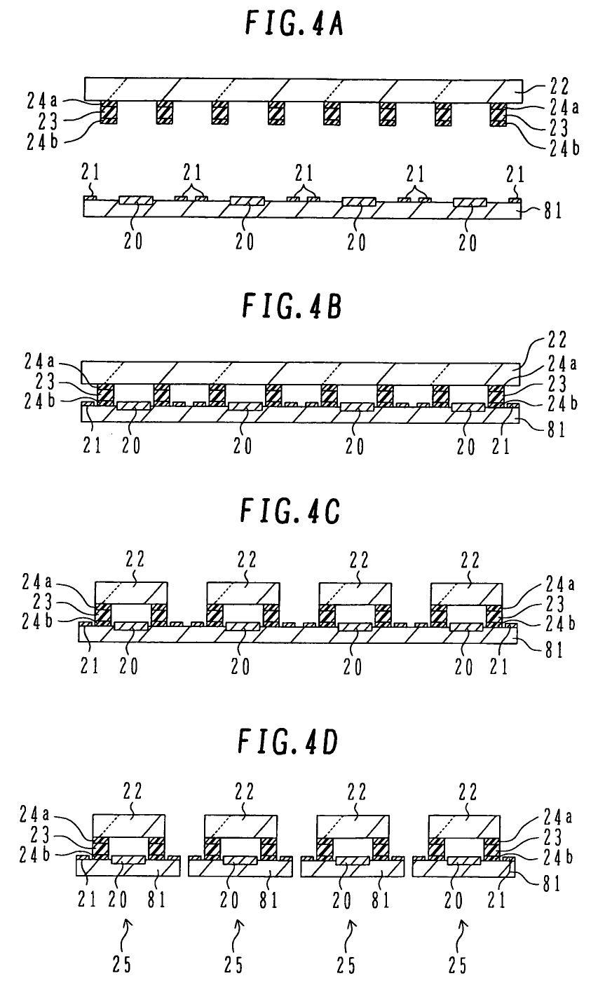

FIG. 5A is a schematic partial plan view of the solid state image pickup device of a chip size level manufactured by the manufacture method described with reference to FIGS. 4A to 4D, and FIG. 5B is a schematic cross sectional view taken along line 5B-5B sown in FIG. 5A.

### DESCRIPTION OF THE PREFERRED EMBODIMENTS

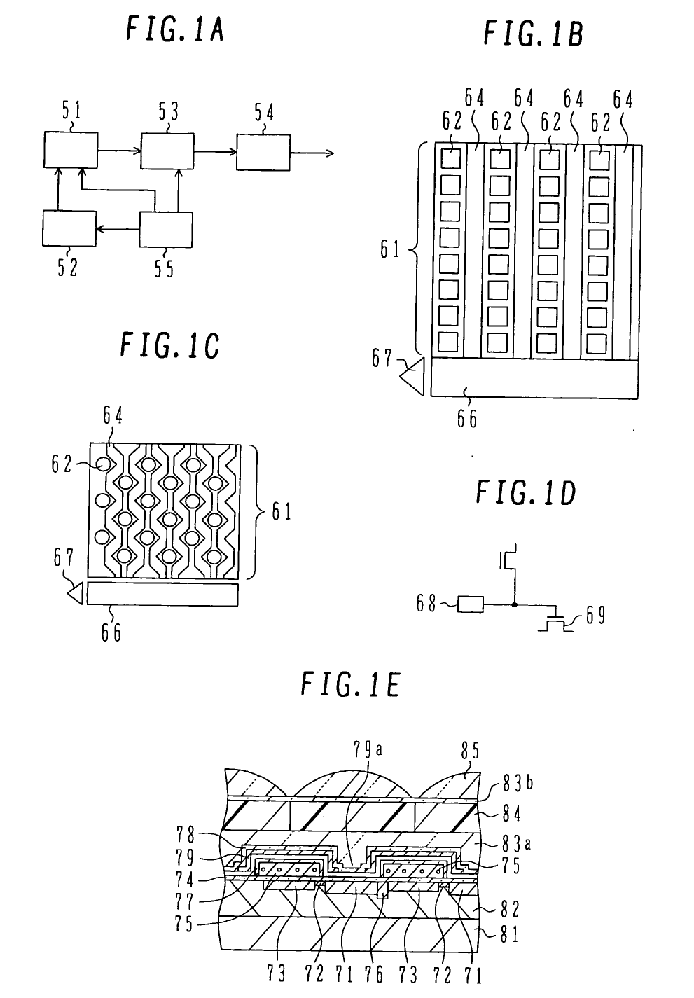

FIG. 1A is a block diagram showing a main part of a solid state image pickup device having solid state image pickup elements, FIGS. 1B and 1C are schematic plan views showing the structure of a CCD type solid state image pickup device, FIG. 1D is a circuit diagram of a MOS type solid state image pickup element, and FIG. 1E is a schematic cross sectional view showing a portion of a light reception unit of a CCD type solid state image pickup element.

Reference is made to FIG. 1A. The structure of a solid state image pickup apparatus will be described. A solid state imaging pickup device 51 generates signal charges corresponding to an amount of light incident upon each pixel and supplies an image signal corresponding to the generated signal charges. A drive signal generator 52 generates drive signals (transfer voltage, etc.) for driving the solid state image pickup device 51 and supplies the drive signals to the solid state image pickup device 51. An analog front end (AFE) 53 subjects an output signal from the solid state image pickup device 51 to correlation double sampling, amplifies the sampled signal at an externally set gain, converts it into a digital signal, and outputs the digital signal. A digital signal processor (DSP) 54 processes an image signal supplied from the analog front end 53, such as recognition process, data compression and network control, and outputs the processed image data. A timing generator (TG) 55 generates timing signals for the solid state image pickup device 51, drive signal generator 52 and analog front end 53, to control the operations thereof.

The solid state image pickup device is roughly classified into a CCD type and a MOS type. The CCD type transfers charges generated in each pixel by charge coupled devices (CCD). The MOS type amplifies charges generated in each pixel by a MOS transistor and outputs the amplified charges. In the following, the CCD type will be described by way of example and not imitatively.

The drive signal generator 52 includes, for example, a V driver for generating a vertical CCD drive signal. Signals supplied from the drive signal generator 52 to the solid state image pickup device 51 include a horizontal CCD drive signal, a vertical CCD drive signal, an output amplifier drive signal and a substrate bias signal.

Reference is made to FIG. 1B. The solid state image pickup device is constituted of: a plurality of photosensors 62 disposed, for example, in a matrix shape; a plurality of vertical CCDs 64; a horizontal CCD 66 electrically connected to the vertical CCDs 64; and an amplifier 67, connected to an output terminal of the horizontal CCD 66, for amplifying an output signal from the horizontal CCD 66. A light reception area (pixel area) 61 is constituted of the photosensors 62 and vertical CCDs 64.

The photosensor 62 is constituted of a photosensitive element, e.g., a photodiode and a read gate. The photodiode generates signal charges corresponding to an incidence light amount and accumulates them. The accumulated signal charges are read from the read gate to the vertical CCD (vertical transfer channel) 64 and transferred in the vertical CCDs 64 as a whole toward the horizontal CCD 66 (in a vertical or column direction). Signal charges transferred from the bottom ends of the vertical CCDs 64 are transferred in the horizontal CCD (horizontal transfer channel) 66 as a whole in a direction crossing the vertical direction, e.g., a horizontal direction (a direction perpendicular to the vertical direction or row direction), and thereafter converted into a voltage signal. The voltage signal is input to the amplifier 67, amplified and output to an external.

The photosensors 62 are disposed in a square matrix layout at a constant pitch in the row and column directions as shown in FIG. 1B, or disposed in a honeycomb layout in the row and column directions by shifting every second photosensors, for example, by a half pitch.

FIG. 1C is a schematic plan view of a solid state image pickup device having the honeycomb layout. The honeycomb layout has photosensors 62 disposed in a first square matrix layout and photosensors 62 disposed in a second square matrix layout at positions between lattice points of the first square matrix layout. Vertical CCDs (vertical transfer channels) 64 are disposed in a zigzag way between photosensors 62. Signal charges are transferred in the vertical transfer channel as a whole in a direction (vertical direction) toward a horizontal CCD 66. Although this layout is called a honeycomb layout, the photosensor 62 of most honeycomb layouts is octangular.

FIG. 1D is a circuit diagram showing a light reception unit of a MOS type solid state image pickup device. Signal charges generated in a photoelectric conversion element 68 and corresponding to an incident light amount are amplified by a MOS transistor 69 and output to an external. The MOS type solid state image pickup device does not have vertical CCDs and a horizontal CCD, but has the photoelectric conversion element 68 and MOS transistor 69 for each pixel.

FIG. 1E is a cross sectional view of a light reception unit of a CCD solid state image pickup device. For example, formed in a p-type well 82 formed in a semiconductor substrate 81, e.g., an n-type silicon substrate, are a charge accumulation region (photodiode) 71 made of an n-type impurity doped region, a p⁺-type read gate 72 adjacent to the photodiode, and a vertical transfer channel 73 made of an n-type region disposed next to the photodiodes 71. A vertical transfer electrode 75 is formed above the read gate 72 and vertical transfer channel 73, with a gate insulating film 74 being interposed therebetween. A p-type channel stop region 76 is formed between adjacent photodiodes 71.

The channel stop region 76 is used for electrically isolating the photodiodes 71, vertical transfer channels 73 and the like. The gate insulating film 74 is a silicon oxide film formed on the surface of the semiconductor substrate 81, for example, by thermal oxidation. The vertical transfer electrode 75 is constituted of first and second vertical transfer electrodes made of, for example, polysilicon. The first and second vertical transfer electrodes may be made of amorphous silicon. The vertical transfer electrode 75 controls potentials at the vertical transfer channel 73 and read gate 72 to read charges accumulated in the photodiode 71 to the vertical transfer channel 73 and transfer the read charges in a column direction of the vertical transfer channel 73.

An insulating silicon oxide film 77 is formed on the vertical transfer electrode 75, for example, by thermally oxidizing polysilicon. The vertical CCD 64 is constituted of the vertical transfer channel 73, upper insulating film 74 and vertical transfer electrode 75. A horizontal CCD 66 is also constituted of a horizontal transfer channel, an upper gate insulating film and a horizontal transfer electrode.

A light shielding film 79 of, e.g., tungsten (W), is formed above the vertical transfer electrode 75, with the insulating silicon oxide film 77 being interposed therebetween. Openings 79a are formed through the light shielding film 79 at positions above the photodiodes 71. A silicon nitride film 78 is formed on the light shielding film 79. The silicon nitride film 78 is not necessarily required.

Signal charges accumulated in the photodiode 71 and corresponding to an incident light amount are read from the read gate 72 to the vertical transfer channel 73 and transferred in the vertical transfer channel 73 by a drive voltage (transfer voltage) applied to the vertical transfer electrode 75. As described above, the light shielding film 79 has the openings 79a above respective photodiodes 71 and prevents light incident upon the light reception area 61 from entering an area other than the photodiode 71.

A planarized layer 83a made of, e.g., boro-phospho silicate glass (BPSG) is formed above the light shielding film 79. On this planarized surface, a color filter layer 84 is formed which is of three primary colors: red (R), green (G) and blue (B). Another planarized layer 83b is formed on the color filter layer 84. On the planarized layer 83b having a planarized surface, micro lenses 85 are formed, for example, by melting and solidifying a photoresist pattern of micro lenses. Each micro lens 85 is a fine hemispherical convex lens disposed above each photodiode 71. The micro lens 85 converges incidence light on the photodiode 71. Light converged by one micro lens 85 passes through the color filter layer 84 of one of the red (R), green (G) and blue (B) and becomes incident upon one photoelectric conversion element (photodiode). Therefore, the photodiodes include three types of photodiodes: photodiodes upon which light passed through the red (R) color filter layer 84 becomes incident; photodiodes upon which light passed through the green (G) color filter layer 84 becomes incident; and photodiodes upon which light passed through the blue (B) colorfilter layer 84 becomes incident.

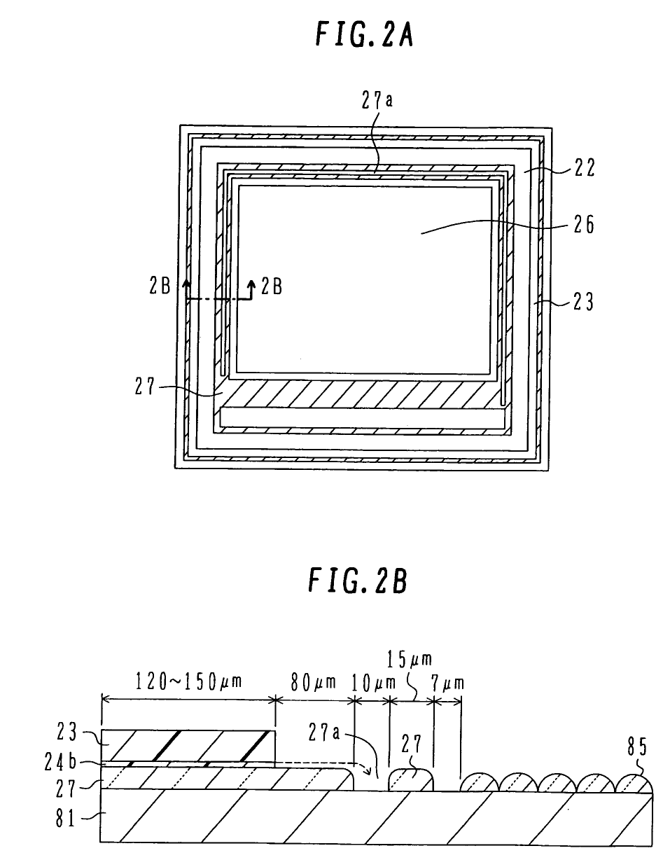

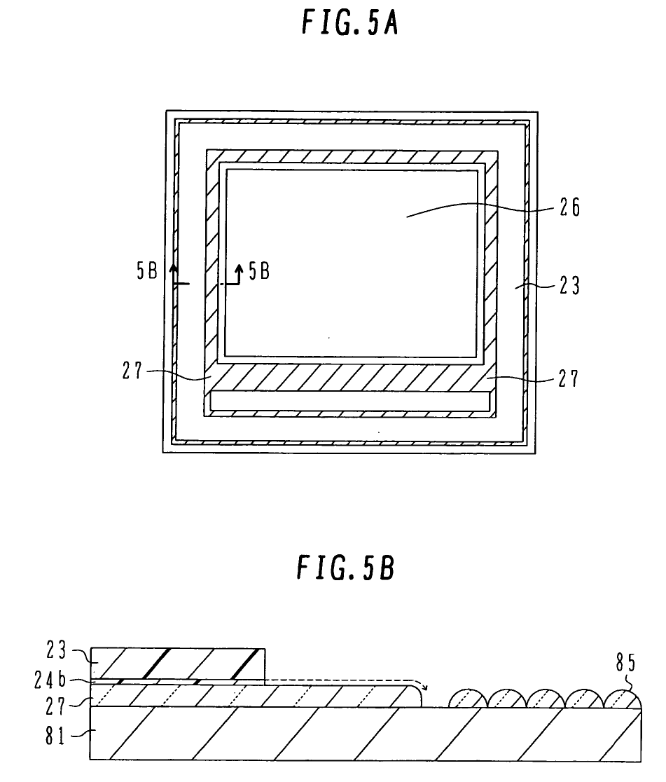

FIG. 2A is a schematic partial plan view of a solid state image pickup device according to an embodiment, and FIG. 2B is a schematic cross sectional view taken along line 2B-2B shown in FIG. 2A. FIGS. 2A and 2B correspond to FIGS. 5A and 5B, respectively. In FIG. 2B, the protective glass 22 is omitted.

Reference is made to FIG. 2A. A spacer 23 is formed on the principal surface of a semiconductor substrate formed with photodiodes, surrounding the outer peripheral area of a light reception area 26 (an area where charge accumulation regions and vertical transfer channels are formed) as viewed in plan. A thickness (height) of the spacer is, for example, 100 μm.

The spacer 23 is adhered to a base 27 for the spacer 23 formed on the semiconductor substrate, for example, with adhesive.

The base 27 is formed surrounding the light reception area 26 not only under the spacer 23 but also in an area nearer to the light reception area 26 than the area of the spacer 23. The base 27 is formed at the same time when micro lenses of the solid state image pickup device are formed, by using the same material as that of the micro lenses. An area where the base 27 is formed is indicated by oblique lines in FIG. 2A.

A trench (recess) 27a is formed through the base 27 between the spacer 23 and light reception area 26, along three sides of the light reception area 26 having generally a rectangular shape.

A protective glass 22 of transparent material having a thickness of, e.g., 250 μm is formed on the spacer 23 to hermetically seal the inner space of the solid state image pickup device.

The protective glass 22 protects the solid state image pickup device from moisture or mechanical impacts. The protective glass 22 prevents dusts from attaching the light reception area 26 during manufacture processes of solid state image pickup devices, mainly during dicing process.

Reference is made to FIG. 2B. A width of the spacer 23 is, for example, 120 μm to 150 μm. A distance from the end of the spacer 23 to the trench 27a is, for example, 80 μm. A width of the trench 27a is, for example, 10 μm. A distance from an end of the trench 27a on the light reception area 26 side to an end of the base 27 on the light reception area 26 side is, for example, 15 μm. A distance from an end of the base 27 on the light reception area 26 side to an area where a micro lens 85 in the light reception area 26 is, for example, 7 μm. A diameter of the micro lens 85 is, for example, 5 μm.

Adhesive 24b outflowed from the bonding area of the spacer 23 is flowed into the trench 27a formed between the spacer 23 and light reception area 26, and is prevented from entering the light reception area 26, while the space is bonded to the base 27 formed on the semiconductor substrate 81. It is therefore possible to manufacture a high quality solid state image pickup device.

Even if the spacer 23 is formed near at the light reception area 26, the presence of the trench 27a can prevent the adhesive 24b from entering the light reception area 26. It is therefore possible to make compact the solid state image pickup device.

In a solid state image pickup device in which a spacer is bonded directly or via an intermediate member (e.g., base) to a semiconductor substrate formed with a solid state image pickup device, the structure that the trench (recess) between the spacer and the light reception area of the solid state image pickup device is formed is applicable to both a solid state image pickup device having pads formed on one side of a semiconductor substrate and a solid state image pickup device having pads formed on both sides of a semiconductor substrate.

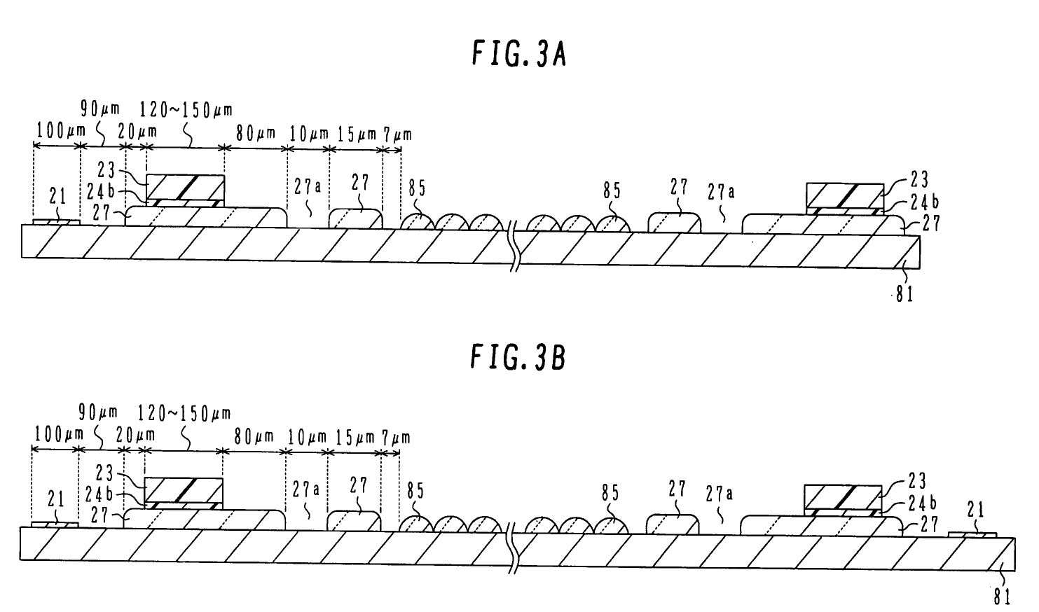

FIGS. 3A and 3B are schematic cross sectional views of solid state image pickup devices having pads formed on one side and both sides of semiconductor substrates.

In FIGS. 3A and 3B, for example, a width of a pad 21 is 100 μm, a distance between the pad 21 and base 27 is 90 μm and a distance between an end of the base 27 on the pad 21 end side and a mount position of the spacer 23 is 20 μm.

In the embodiment, although the spacer is bonded, other members may also be used which are bonded directly or via an intermediate member to a semiconductor substrate formed with a solid state image pickup device. In this case, a recess is formed through the member between the member and the light reception area of the solid state image pickup device. It is therefore possible to prevent adhesive from entering and attaching the light reception area. It is therefore possible to manufacture a high quality solid state image pickup device. By adopting this structure, the solid state image pickup device can be made compact.

The invention is suitable for a solid state image pickup device having a member (e.g., spacer) to be bonded to a semiconductor substrate formed with solid state image pickup device. The invention is suitable for a solid state image pickup device required to be made compact.

The present invention has been described in connection with the preferred embodiments. The invention is not limited only to the above embodiments. It will be apparent to those skilled in the art that other various modifications, improvements, combinations, and the like can be made.

What we claim are:

1. A solid state image pickup device comprising:
a semiconductor substrate having a light reception area and formed with a solid state image pickup device;
a base formed on said semiconductor substrate in an area outside the light reception area;
a first member bonded to a partial surface of said base;
a recess formed through said base in an area between the light reception area and said first member; and
a second member supported by said first member, disposed above said light reception area and hermetically sealing the light receiving area.

2. The solid state image pickup device according to claim 1, further comprising micro lenses formed above the light reception area and made of material same as material of said base.

3. The solid state image pickup device according to claim 1, wherein the solid state image pickup device is a CCD type solid state image pickup device.

4. The solid state image pickup device according to claim 1, wherein the solid state image pickup device is a MOS type solid state image pickup device.
